(19) United States
(12) Patent Application Publication
(10) Pub. No.: US 2009/0185875 A1
(43) Pub. Date: Jul. 23, 2009

(54) Machining Tool and Method For The Production Thereof

(75) Inventor: Martin Frank, Aachen (DE)

Correspondence Address: BANNER & WITCOFF, LTD., 1100 13th STREET, N.W., SUITE 1200, WASHINGTON, DC, 20005-4051, US

(73) Assignee: CemeCon AG, Wurselen (DE)

(21) Appl. No.: 11/663,625

(22) PCT Filed: Sep. 21, 2005
(86) PCT No.: PCT/EP05/10212

§ 371 Date: Apr. 3, 2009

(30) Foreign Application Priority Data
Sep. 23, 2004 (DE) 10 2004 046 478.2

(51) Int. Cl. B23P 15/34; B32B 3/00; B44C 1/22

(52) U.S. Cl. 407/114; 428/172; 216/41

(57) ABSTRACT

The invention relates to a machining tool having a determined or non-determined cut and to a method for the production thereof. The tool is provided with a hard metal substrate (10). A diamond or DLC layer (12) is applied to the substrate (10). Several edges (16) are formed by abrupt alteration of layer thickness in the surface of the diamond or DLC layer (12). The diamond or DLC layer is applied using a CVD method. The diamond layer is applied using a CVD method and the DLC layer is applied using a PVD or CVD method. A mask (14) is applied to the layer. The edges (16) are produced by etching points on the surface that are not covered by the mask. As a result, it is possible to significantly increase the functionality of the tool. The edges (16) can be used as additional cutting edges or free areas can be transformed for discharging coolants or lubricants and removed material.

The invention relates to a machining tool and a method for the production thereof.

Different tools are known for machining production, including those with a (geometrically) determined cut (turning, boring, milling) and those with a (geometrically) undetermined cut (grinding, honing, lapping, polishing).

It is known to apply diamond layers to the functional surfaces of tools in order to improve wear protection. Thus, machining tools with determined cuts, e.g. indexable inserts, are known that have a diamond layer in the cutting area.

The use of diamond layers is also known for tools with an undetermined cut. Thus, DE-U-29707111 discloses a grinding disk for grinding glasses, gemstones and suchlike. The disk consists of sintered hard material, e.g. sintered hard metal made of WC/Co. While diamond-coated sinter ceramic pellets are deposited to the surface as abrasive particles in a first example, island-like zones with a diamond coating form an abrasive coat in a second example. The diamond layers are deposited in the CVD method. For the formation of island-like areas, the areas not to be coated are covered during the deposition process.

The method disclosed in DE-U-29707111 for the production of island-like areas can lead to reduced adhesion and increased risk of crack formation, since during the removal of the—also inevitably coated—covering, the coated areas can also be affected. Moreover, the masking of substrates during the coating is relatively problematic. Most mask materials are not stable under the extreme conditions of the CVD diamond coating of typically 900° C. and reactive gases and radicals for periods of several hours.

DE-A-103 26 734 discloses a diamond milling tool and a method for the production thereof. A large-surface silicon substrate is thereby coated with a synthetic diamond layer. A mask structured using photolithography is formed on the substrate so that a masking in the form of the outline of the later diamond tool is formed. The unmasked part of the substrate is then chemically removed by etching. In a subsequent etching step, the remaining part of the substrate is etched together with the diamond layer in a reactive ion etching process so that the desired diamond tools remain. Different milling edge angles are achieved on the ultimately remaining diamond body through the different composition of the process gas. Silicon, silicon carbide, glass, refractory metals, sapphire, magnesium oxide and germanium are named as other etchable substrate materials.

The diamond bodies disclosed in DE-A-103 26 73 may be produced with high precision, but require special measures for use as a tool, e.g. clamping. The described process is quite complex, but only relatively flat forms of diamond tools can be produced.

Moreover, diamond coatings are also used in other areas. JP-A-07-223897 discloses the production of a semiconductor component. A thin diamond layer with a thickness of 1 μm is deposited to a substrate using a CVD method. The required structures are subsequently inserted into this layer in that a mask is applied and the unmasked areas are removed in a reactive plasma etching process. An aluminum coating with a thickness of approx. 500 nm serves as the mask.

In addition to diamond layers, DLC layers (diamond-like carbon) are also known that can be deposited in PVD or CVD procedures.

The object of the invention is to specify a machining tool and a method for the production thereof, wherein a favorable surface finish is achievable in a simple manner.

This object is solved through a tool according to claim 1 and a method according to claim 11. Dependent claims refer to advantageous embodiments of the invention.

The tool suggested according to the invention has a hard metal substrate with a diamond or DLC layer. Hard metal here is to be understood in the broadest sense as sinter material, in which carbides, nitrides, oxides, borides or silicides of the metals of the IUPAC groups 4, 5 and 6 of the periodic system of elements are integrated in a binder matrix made of cobalt, nickel or iron or alloys thereof. Hard metals consisting predominantly of WC with Co as the binder are preferred; pure WC—Co hard metals that are made exclusively of or at least up to 98 wt.-% WC—Co are especially preferred.

The deposited layers consist of carbon, which is predominantly present in a crystalline structure with sp³ bonding (diamond layer) or in an amorphous structure with sp²/sp³ bonding, if applicable with hydrogen (DLC layer). These types of diamond layers can be deposited on the hard-metal substrate in the CVD procedure in a manner known in principle to a person skilled in the art. Nanocrystalline layers or multi-layers with nanocrystalline layers are preferred for diamond layers, because they have a low tendency to crack. DLC layers can be deposited in PVD or CVD procedures in the known manner.

On one hand, such a layer can be deposited directly to the hard metal substrate. However, alternatively, it is also possible to join the—separately produced—layer with the substrate later on, e.g. through soldering. This technique is inherently known for thick layers with a thickness of typically more than 100 μm. More information can be found in VDI guideline VDI-2840 (carbon layers), in which the term DLC is also explained in greater detail.

In the method according to the invention, a mask is applied to the diamond or DLC layer, and the layer is subsequently subjected to an etching process, in which the masking material remains largely uncorroded. Thus, the diamond or DLC layer is etched primarily only on the areas of the surface that are not covered by the mask. Depending on the duration and intensity, the etching removes the layer at these spots either fully, i.e. down to the substrate, or only partially so that it receives a smaller layer thickness there. The transition between the original layer thickness (under the masking) and the reduced layer thickness or the areas freed from the layer is abrupt so that edges form at these spots.

Here, the layer thickness is reduced to a value of preferably less than 80% of the original layer thickness, so that distinct edges form. Even deeper edges up to a remaining layer thickness of less than 50% are especially preferred; less than 10% is even more preferred. Within the scope of the method according to the invention, complete removal is possible. If, as is preferred, a remaining layer thickness remains on the etched areas after the etching, the surface of the tool is further protected by a continuous diamond or DLC layer. A remaining layer thickness of at least 0.5 μm is preferred here.

The edges formed in this manner can be used especially advantageously in machining. These edges are relatively sharp due to the abrupt transition of the layer thickness. However, completely sharp edges of e.g. 90° are not normally created due to unavoidable inhomogeneities during the etching process. Nevertheless, a very specific surface structure with additional edges, through which different functionalities beneficial for the machining are fulfilled, is created in a simple manner with the method according to the invention. On the one hand, the edges can serve as additional cutting edges. On the other hand, free areas for discharging cooling lubricants and removed materials or for chip breaking or chip guiding can be formed in this manner. In the case of polishing tools, the depressions can serve to carry or hold the polishing agent.

Further, the surface structure according to the invention can also be used to label the tool itself (to differentiate it from other tools) or to mark individual parts of the tool (e.g. from different cutting corners of an indexable insert).

Alternatively, the closed layer on the tool according to the invention, in which edges are present in the surface but the area between the edges is further covered by the layer, can also be created in that the layer is first completely removed by etching on the unmasked areas and the tool is subsequently over-coated with another diamond or DLC layer.

In accordance with a further embodiment of the invention, the transitions of the layer thicknesses in the surface of the diamond or DLC layer are selected such that several protruding islands are formed. However, the area between the islands continues to remain covered by diamond or DLC due to the still remaining layer thickness (or due to the over-coating).

The tool can be a tool with a non-determined cut. In accordance with a further embodiment of the invention, the tool is an abrasive tool. This embodiment takes advantage of the fact that surface roughness of the layer is increased by the structure formed on the surface of the diamond or DLC layer.

In the case of a distinct transition of the layer thickness at the edges, wherein the stage height is at least 20%, preferably at least 50%, most preferably at least 90% of the layer thickness, considerable surface roughness is achieved. The stage height in μm hereby corresponds approximately the roughness values as per Rz in DIN and ISO.

The tool according to the invention can have any form. The substrate is preferably a tool base body, which has at least one holding area (e.g. shaft or clamping surface) and a processing area (determined or non-determined cut). On one hand, it is possible that the tool base plate itself already has the tool functionality of the processing surfaces (e.g. determined cuts or grinding surface with roughness), which is then enhanced by the coating and subsequent structuring of the layer surface. On the other hand, it is also possible that the functionality of the processing surfaces is first created through the coating and structuring, that is, that e.g. cutting edges are created only through the formation of edges or the roughness of a grinding surface only through the structuring.

A preferred shape for the latter case is the pin shape. A pin-shaped tool can be provided with a determined cut, e.g. milling pin, or serve as a tool with a non-determined cut, e.g. as a grinding pin, honing needle, file, polishing pin.

In accordance with a further embodiment, the tool is a machining tool with a determined cut, e.g. an indexable insert, a milling cutter or a drill. In a preferred embodiment, the cutting edge has a chip surface (true rake), onto which the diamond or DLC layer is deposited. Structures for guiding or breaking the chip are provided on the surface of the layer on the chip surface. In tools with a determined cut, in particular indexable inserts, it is often beneficial that the chip surfaces have a higher surface roughness, in order to encourage the breaking of the chips. Furthermore, defined structures can be present on the chip surface in order to break or divert the chip. For example, a trench on the chip surface can also serve as a chip guiding stage or a chip breaker. Using the method according to the invention, these structures can be produced very exactly.

In the method according to the invention, different variants of the CVD method known to a person skilled in the art can be used. A hot filament method is preferred. In principle, all materials resistant under etching conditions can be used as the masking material. Masks can be applied with all usual coating methods. In the simplest case, the masking can take place through the placement or mechanical application of the masking material. Very exact structures can e.g. be created with photolithographic procedures, which are known to a person skilled in the art from the semiconductor industry. The masking material is preferably removed after the etching through irradiation, ultrasound, chemical procedures or other cleaning procedures.

The etching of the diamond or DLC layer preferably takes place in an oxygen-containing plasma. Here, the substrate can be held permanently or temporarily at negative potential. Mask and substrate are preferably not etched in the process.

Embodiments of the invention are described below in greater detail using drawings. The drawings show:

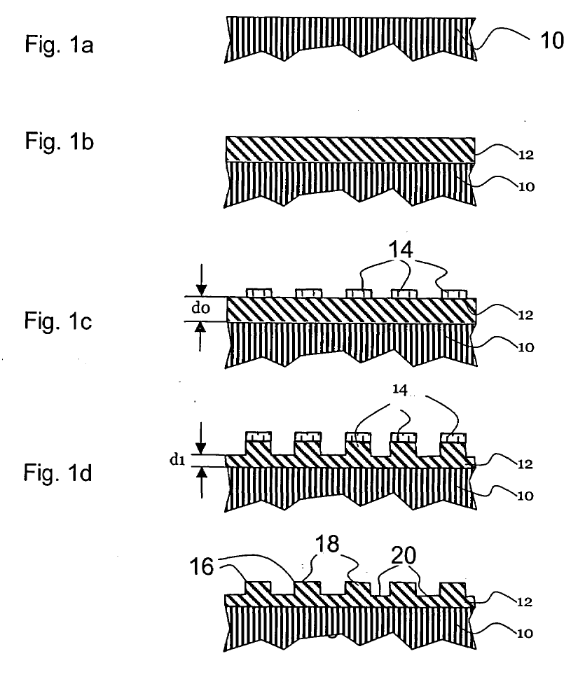

FIG. 1a-1e Process steps of a first production method for a body with a structured surface coating;

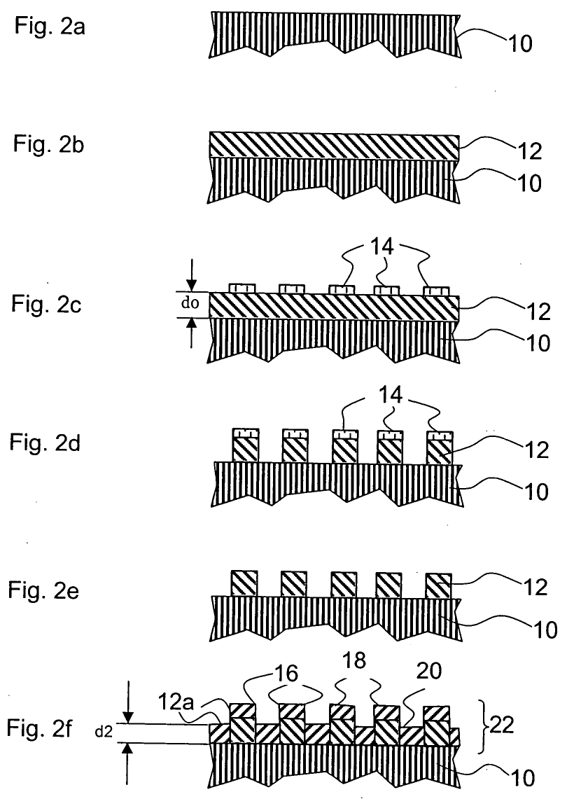

FIG. 2a-2f Process steps of a second production method for the production of a structured surface coating;

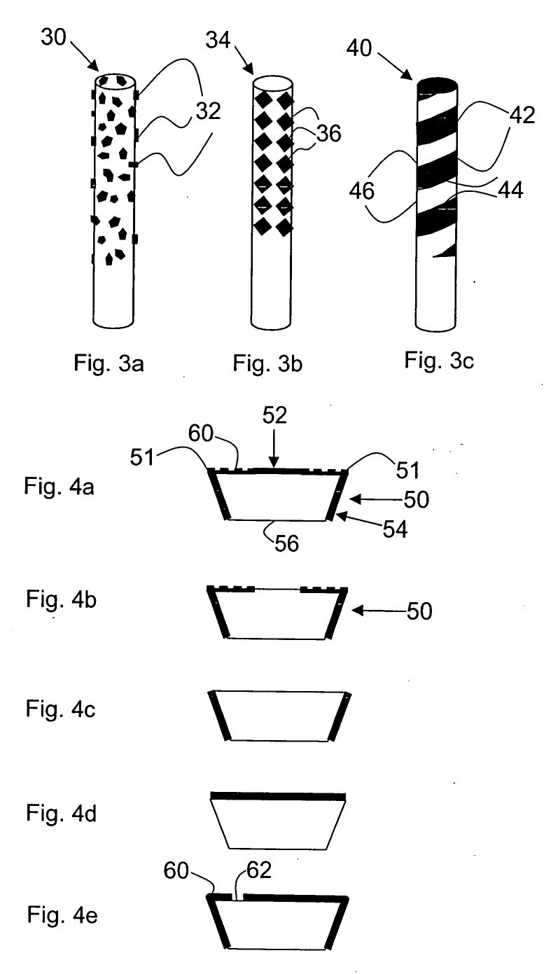

FIG. 3a A perspective view of a first embodiment of a tool in the form of a grinding pin;

FIG. 3b A perspective view of a second embodiment of a tool in the form of a milling pin;

FIG. 3c A perspective view of a third embodiment of a tool in the form of a milling pin;

FIG. 4a-4e Different embodiments of an indexable insert with structures etched into different surfaces;

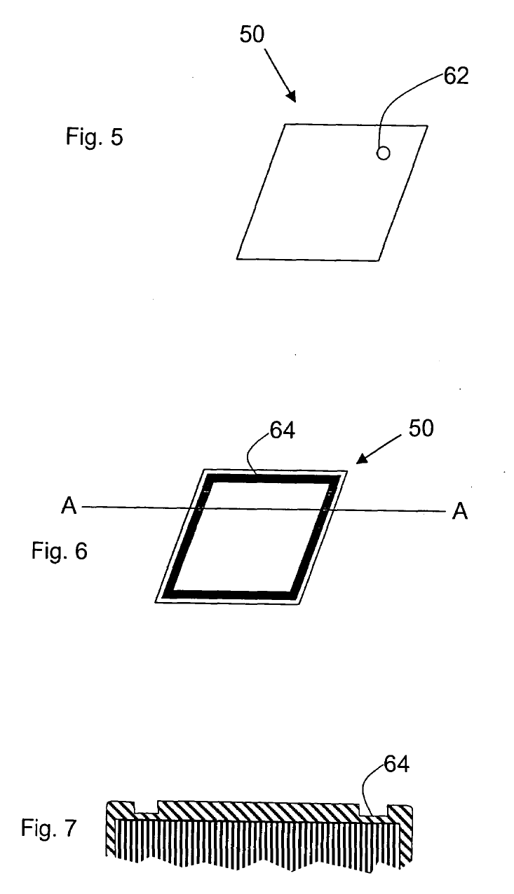

FIG. 5 A top view of the indexable insert with marking from FIG. 4e;

FIG. 6 A top view of another embodiment of a tool in the form of an indexable insert with circumferential trench;

FIG. 7 A partial cross-sectional view of the indexable insert from FIG. 6 along the intersecting line A . . . A.

The invention assumes the fundamental idea that the functionality of diamond and DLC layers on components and tools can be increased considerably if the layer is structured in that it is removed again at select spots or reduced in thickness. This applies in particular for machining tools with a determined or non-determined cut. The structures created through selective removal can serve to form additional cutting edges, free areas for discharging cooling lubricants and removed material, labeling the tool, applying markings or keeping surfaces free of the coating for the machining of the tool. The tool functionality can thus be supported. It is also possible to first create the actual tool functionality through the formed structures, e.g. processing edges.

One embodiment of the method according to the invention is explained below using the sequence of steps shown in FIG. 1a-1e.

First, a body 10 is prepared from a substrate material (FIG. 1a). The substrate material is a hard metal, e.g. WC/Co. Alternatively, the substrate material can also be a cermet. The body 10 is preferably a tool base body.

The body 10 is coated—at least on the functional areas that are in contact with the material to be machined (by removing chips)—with a layer 12 in a CVD procedure. The layer 12 can be a diamond layer or a DLC layer. A DLC layer can also be deposited in a PVD procedure. Below, the layer 12 is only described as a diamond layer, whereby it should be clear that it can just as well be a DLC layer. The layer thickness d0 can be selected between a broad range of very thin layers (e.g. 0.1 μm) to very thick layers (e.g. 500 μm). The layer thicknesses d0 preferably lie in the range of 0.5-80 μm, most preferably 1-20 μm. The diamond layer 12 is preferably deposited in a hot filament-CVD procedure.

A masking 14 is subsequently applied to the surface of the diamond layer 12. The spots on the diamond layer 12 that are not to be etched in the next step are hereby covered.

The body masked in this manner is subsequently subjected to an etching treatment in an oxygen-containing plasma, wherein the body is negatively biased against the plasma. As can be seen in FIG. 1d, a surface structure is created within the layer 12, in which parts of the layer 12 are removed on the unmasked spots, while the mask 14 and the areas directly below it remain largely untouched.

On the unmasked spots, the layer 12 is reduced from its original layer thickness d0 to a smaller layer thickness d1. The etching depth can be influenced by the duration of the etching treatment. The etching treatment is preferably performed for so long that the ratio d1:d0 is less than 80% or less than 50%, most preferably less than 10%, wherein a remaining layer thickness d1 of at least 0.5 μm is preferably retained.

The mask can be removed using different procedures, e.g. through mild sand-blasting.

The etching treatment creates steep sides with edges 16 on the edges of the masked areas. The masked areas remain—according to the form of the mask—as island-like areas 18, wherein the intermediate, recessed areas 20 remain covered by the layer 12—in the remaining layer thickness d1. Thus, the layer 12 is also a continuous layer. A number of edges 16 are formed in the surface of the layer through the abrupt transition between original layer thickness d0 and the reduced layer thickness d1. The edges 16 can be used in the machining. The roughness of the layer surface is increased considerably through the created stages. The recessed areas 20 can also fulfill different functions (coolant/lubricant transport, chip guiding, chip breaking, etc.).

The crack-prone layer/substrate interface is well protected from mechanical effects due to the completely closed layer 12. The surface is made up to 100% of diamond. The advantages of the diamond material such as high hardness, chemical inertness, etc. are thus retained.

It is hereby noted that the circumstances shown in FIG. 1a-1e are naturally idealized. Due to unavoidable inhomogeneity effects during etching, the exactly sharp 90° edges as shown in FIG. 1d, 1e are not possible in reality.

The steps of an alternative production method are shown in FIG. 2a-2f. As in the method explained above, a substrate 10 is coated with a diamond (or DLC) layer, provided with a masking 14 and subjected to an etching process (FIG. 2a-2d). In contrast to the method described above, the etching process is, however, performed in full so that the layer of the original layer thickness d0 is completely removed from the unmasked areas. The substrate is not or only minimally affected by the etching process (thin oxide skin). The mask 14 and if applicable the thin oxide skin are removed e.g. through mild sand-blasting.

In a subsequent optional step, the body is over-coated with another layer 12a. As shown in FIG. 2f, a body 10 with one (consisting of the two layers 12 and 12a) closed diamond or DLC layer is created. The layer has a number of edges 16 on its inside. Protruding, island-like areas 18 and deeper-lying intermediate areas 20 are formed.

The additional layer 12a is also deposited in the CVD procedure (or, in the case of DLC, also in the PVD procedure). It has a (medium) layer thickness d2, which can lie e.g. between 0.5 to 10 μm, preferably between 1 to 2 μm. The layer 12a can have the same material and the same (diamond) structure as the original layer 12, but it is also possible for layer 12a to have a different structure.

For example, the inner layer 12 can be a (slightly rougher) microcrystalline diamond layer, while the outer layer 12a is a (smoother) nanocrystalline diamond layer or DLC layer. This results in less friction.

In the alternative method, a body 10 is also created, in which the substrate is covered by a closed layer 22.

A first concrete exemplary embodiment of a tool and method for the production thereof according to the invention is explained below with regard to FIG. 3a.

A hard metal cylinder 30 with a length of 60 mm and a diameter of 3 mm is coated with a 10-μ-thick CVD diamond layer. The diamond layer is masked with a suspension made of fine-particle titanium oxide with a particle size of approx. 0.5 μm. The solvent is subsequently evaporated in air or in a cabinet drier.

The cylinder 10 is etched in a vacuum system under glow discharge in oxygen with the following parameters:
Oxygen flow 100 ml/min
Pressure 1 hPa
Electric power 800 W, 250 Veff with 50 kHz sym. AC voltage, the substrate is thereby biased against the metallic chamber walls.
Substrate temp. approx. 450° C.
Chamber volume approx. 30 l
Chamber dimension approx. 30×30×30 cm
Duration 9 hours.

The finished tool 30 can be used as a file or rotating grinding pin. There is a rough but continuous diamond layer on the surface. In accordance with the previous masking, the diamond layer has protruding, island-like areas 32 with steep flanks and edges formed on it.

Very different surface structures for abrasive tools can be created in an exact manner with the described production method. The broad range of roughnesses can be created through the layer thickness and the depth of the etching. It is thus possible to adjust almost all classifications of manufacturers of abrasives conventional for abrasive tools. The classification of particle sizes of conventional diamond abrasive tools is often aligned with the EFPA Standard for Diamond Granularity. The excess grain size, which constitutes 20-50% of the grain diameter on average depending on the type of adhesive agent and manufacturer specifications, is created during the embedding of the grains in conventional diamond abrasive tools with diamond grains embedded into the adhesive agent. In contrast, there is a stage height (difference d0−d1) on the edges in the tool described above. In order to achieve consistency between the surface structure produced in this manner and conventional abrasive tools, the stage height is selected according to the excess grain size and the number of edges according to the concentration of grains in the abrasive coat.

If one assumes that the diamond abrasive grains of conventional abrasive tools protrude up to 25% out of the bonding on average, one can recreate the FEPA grain designations D426 through D46 with an up to 100-μm-thick diamond layer depending on the stage height. The FEPA standard for sieved grains (code letter D) ends with D46. D46 can also be easily achieved with a 12-μm-thick layer, if one etches almost over the entire layer thickness except for a small remaining layer thickness of e.g. approx. 0.5 μm. Similarly, D91 can be recreated with an approx. 20-μm-thick layer. The FEPA Standard for Fine Grain Sizes M63 through M1.0 begins accordingly. In principle, there is no lower limit, if the stage heights are selected small enough. With M4.0 and M1.0, one comes, however, into the range of natural roughness of micro-crystalline diamond layers so that these granularities are also achieved without etching.

A tool produced in this manner can be used as a replacement for conventional abrasive tools with grain sizes M6.3 through D91. Since fine grains and/or uniform excess grain sizes are hard to produce, the body produced as described above shows special advantages. Also, it is difficult to produce grinding pins or honing needles with smaller diameters. Thus, the production according to the invention has special advantages if the tools have small diameter, e.g. smaller than 1 mm. It is even possible to produce tools with an especially small diameter of less than 0.3 mm or even less than 0.1 mm in this manner.

As an alternative to the etching treatment described above for partial removal of the layer, it can be performed—with the same parameters—for a longer period of time in order to completely remove the unmasked layer. After approx. 10 hours, the 10μ diamond layer outside the masking can be completely removed. As explained in connection with FIG. 2a-2f above, the created structure will now be over-coated with another diamond layer.

Another exemplary embodiment is explained with regard to FIG. 3b. A milling pin is produced from a hard metal cylinder 34. The cylinder is coated with a 15 μm-thick CVD diamond layer. A masking is applied so that a regular structure of rectangular, island-like areas 36 is created on the surface. The mask can be applied by means of a thin, stainless-steel cylinder casing, the surface of which has a pattern with rectangular holes and which is put over the pin 34 in a flush manner. The casing can either serve directly as a mask for the etching so that a pattern with rectangular depressions is created in the layer. Alternatively, the casing itself can also be used as a mask for e.g. an deposition procedure, e.g. PVD, so that a masking material, e.g. aluminum, is deposited by evaporation. A pattern with rectangular-shaped islands is then created in the layer during etching.

The etching procedure described above is performed for a duration of 10 hours so that the diamond layer is removed from the unmasked areas up to a remaining layer thickness d1 of approx. 5 μm. The island-like areas 36 thus protrude approx. 10 μm out of the recessed areas. Their sharp edges can serve as machining edges.

Another exemplary embodiment is explained in terms of FIG. 3c. A hard metal milling tool 40 has a diamond layer with a thickness of 12 μm. A mask is thereby created so that the pin 40 wrapped in a spiral-like manner with aluminum foil and a TiAlN layer with a thickness of approx. 0.5 μm is applied by means of sputtering. The foil is then removed so that the previously covered areas have no further coating on the diamond layer.

The pin 40 is then subjected to an etching treatment as described above, wherein the TiAlN layer works like a mask. In the surface of the diamond layer, edges 44 are now formed on the edges of the spiral-shaped, increased areas 42. Between the increased areas 42 runs a spiral-shaped trench 46, through which chips are transported away during the use of the tool 40.

If the aluminum foil fits closely enough, it can also be used as a mask. The analog negative structure is created.

FIG. 4a through 4e show additional examples of possible applications of the invention using the example of an indexable insert 50 coated with a CVD diamond layer.

FIG. 4a shows an indexable insert 50 coated with a diamond layer 60 with a chip surface 52, blades 51 and end flanks 54. A bottom side 56 is not coated, since it was bearing on the substrate holder during the CVD diamond coating or was later freed from the diamond layer 60 with the described etching procedure. The indexable insert 50 was treated on the chip surface 52 with the procedure described above so that an increased roughness was achieved at this spot. This encourages the breaking of the chips.

In the indexable insert 50 shown in FIG. 4b, a part of the free area 52 was completely freed from the diamond layer in an etching procedure in order to avoid the direct contact of the adhesive agent with the sensitive diamond layer when the indexable insert is clamped or soldered.

The indexable insert shown in FIG. 4c shows an entirely etched chip surface 52. The indexable insert shown in FIG. 4d shows completely etched end flanks 54.

In the indexable insert 50 shown in FIG. 4e, a punctiform marking 62 is etched in the diamond layer 60 on the chip surface 52. The indexable insert 50 is shown again in FIG. 5 in a top view. The permanent marking 62 marks one of the cutting corners, so that the user can tell the difference between the cutting corners. Thus, a newly introduced indexable insert can e.g. always be used with the marked cutting corner and turned after it has worn out.

In tools with a determined cut, in particular in indexable inserts, certain structures can be etched in, which have a beneficial effect on the chip workflow and function as a chip guidance stage or as a chip breaker.

FIG. 6 and the cross-section in FIG. 7 show an indexable insert, in which a circumferential trench 64 is provided on the chip surface. The chip is hereby guided and broken.

The methods and tools described above are only to be taken as examples. A plurality of variants and enhancements are possible, including the following, in particular:
Additionally or alternatively to a marking within the tool as described in connection with FIG. 4e, FIG. 5, an extensive labeling of the tool can also be provided in order to differentiate it from other tools. For example, characters or company logos can be etched in. The labeling created in this manner is permanent.
The diamond or DLC layer can be doped with doping substances, e.g. boron, for higher oxidation resistance.
Diamond layers can also be completely removed with the described etching procedure. A coated, damaged tool can thus be reprocessed, e.g. reground, and then recoated.
If DLC layers are used instead of diamond layers, the etching times are considerably shorter. For example, a 10-μm-thick DLC layer was completely removed in the case of the procedural parameters specified above within approx. 2 hours. An only partial etching is established on the surface through correspondingly shorter application.
In principle, the method can be used on all diamond tools and semi-finished diamond parts, e.g. CVD thick layer blades, also on conventional monocrystalline (MCD) and polycrystalline diamond tools (PCD) in addition to the mentioned thin and thick CVD layers.

1. Tool for machining with a determined or non-determined cut with
a hard metal substrate
and a diamond or DLC layer on the substrate
wherein several edges formed through the abrupt transition of the layer thickness are present in the surface of the diamond or DLC layer.

2. Tool according to claim 1, in which
at least one deeper lying area is provided in the surface of the diamond or DLC layer for discharging removed material and/or coolant or lubricant.

3. Tool according to claim 1, in which
several protruding islands are formed on the surface of the diamond or DLC layer.

4. Tool according to claim 1, in which
the tool is an abrasive tool.

5. Tool according to claim 1, in which
the tool has a pin shape.

6. Tool according to claim 1, in which
the tool is a machining tool with a determined cut.

7. Tool according to claim 6, in which
the blade has a chip surface, wherein the diamond or DLC layer is deposited at least on parts of the chip surface,
wherein structures for breaking or guiding a chip are provided on the surface of the diamond or DLC layer on the chip surface.

8. Tool according to claim 6, in which
the tool is an indexable insert.

9. Tool according to claim 1, in which
the diamond or DLC layer comprises at least a first layer and a second layer deposited at least to parts thereof.

10. Tool according to claim 1, in which
a label or marking (62) is formed by the edges (16) introduced in the surface of the diamond or DLC layer (21, 22).

11. Method for the production of a tool with a determined or non-determined cut, in which
a diamond or DLC layer is deposited to a hard metal substrate,
a mask is applied to the diamond or DLC layer,
and the diamond or DLC layer on the spots without the mask is entirely or partially removed through etching so that several edges of the diamond or DLC layer are created on the surface of the tool.

12. Method according to claim 11, in which
the diamond or DLC layer is etched in an oxygen-containing plasma.

13. Method according to claim 11, in which
the substrate is not etched during the etching.

14. Method according to claim 11, in which
the diamond or DLC layer is deposited in a hot filament/CVD procedure.

15. Method according to claim 11, in which
the diamond or DLC layer on the areas with the mask is completely removed.
and another diamond or DLC layer is subsequently deposited to the surface of the tool.

16. Tool according to claim 7, in which
the tool is an indexable insert.
